(19) United States
(12) Patent Application Publication
(10) Pub. No.: US 2023/0153868 A1
(43) Pub. Date: May 18, 2023

(54) AUTOMATIC CUSTOMER FEEDBACK SYSTEM

(71) Applicant: INTUIT INC., Mountain View, CA (US)

(72) Inventor: Vishnu Priya T.G., Bangalore (IN)

(73) Assignee: INTUIT INC., Mountain View, CA (US)

(21) Appl. No.: 17/525,821

(22) Filed: Nov. 12, 2021

(51) Int. Cl. G06Q 30/02; G06Q 30/00; G06F 9/54

(52) U.S. Cl. CPC G06Q 30/0282; G06Q 30/016; G06F 9/547

(57) ABSTRACT

A computing system monitors interaction of a user with a dialog in an application executing on a user device associated with the user. The user is executing a workflow associated with the dialog. The computing system determines a time the user spent executing the workflow associated with the dialog based on the monitoring. The computing system determines whether the user successfully executed the workflow based on the monitoring. The computing system generates a time flow metric for the dialog based on the time the user spent interacting with the dialog. The computing system generates a flow scale metric based on whether the user successfully executed the workflow. The computing system automatically generates a user experience rating for the dialog based on the user metric values. The user experience rating is a weighted representation of the time flow metric and the flow scale metric.

### BACKGROUND

Customer feedback is an important aspect for companies looking to improve their product usage. Customer feedback can provide a company with a clue as to what the customer really desires, whether the customer is comfortable using the product, and whether there any improvements that may be done to the customer experience to increase the net promotor score of a product or feature of a product.

### BRIEF DESCRIPTION OF THE FIGURES

FIG. 1 shows an example computing environment, according to various embodiments of the present disclosure.

FIG. 2 is a block diagram illustrating a back-end computing system, according various embodiments of the present disclosure.

FIGS. 3A-3C illustrate an exemplary dialogue of an application at various stages of a workflow, according to example embodiments.

FIGS. 4A-4C illustrate an exemplary dialogue of an application at various stages of a workflow, according to example embodiments.

FIG. 5 is a flow diagram illustrating a method of automatically generating user feedback for an application, according to example embodiments.

FIG. 6 is a block diagram illustrating an example computing device, according to various embodiments of the present disclosure.

### DETAILED DESCRIPTION OF SEVERAL EMBODIMENTS

Customer feedback on a product is important to any business or company seeking to improve their product or features of their product. The difficulty with customer feedback, however, is that companies typically only receive feedback from 20-30% of the customer base. Such low feedback numbers may be attributed to the time demand on customers for supplying that feedback. To address the participation issue, one or more techniques described herein provide an automatic feedback system, in which the customer's time and experience with a company's product may be tracked. Based on this tracked data, the present system is configured to automatically generate feedback for the product or a feature of the product. In this manner, a company may be presented with sufficient feedback data in order to properly fine tune or adjust their product.

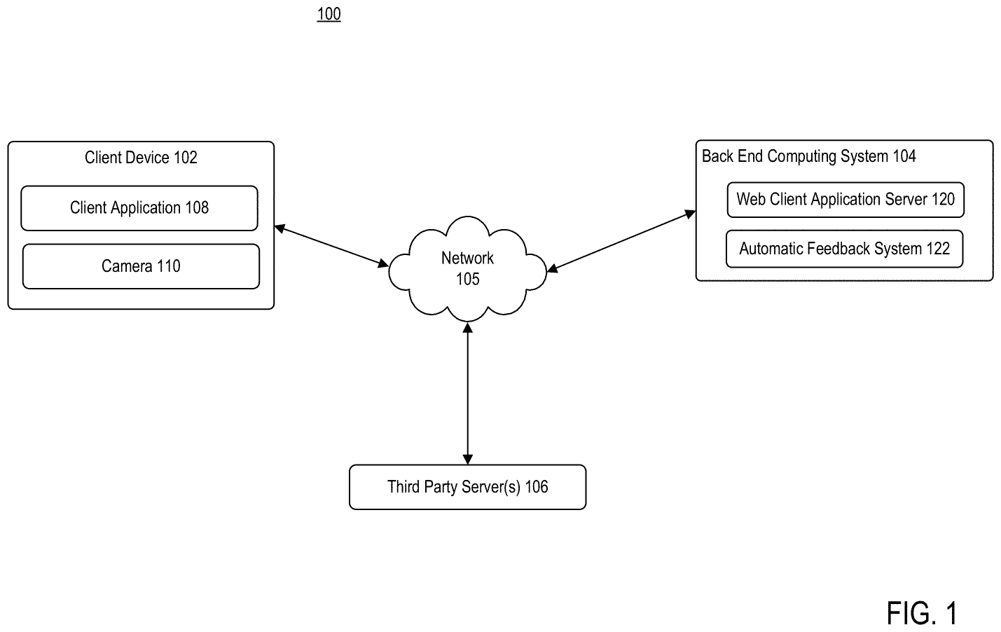

FIG. 1 shows an example computing environment 100 configured to implement an automatic feedback process, according to embodiments of the present disclosure. Computing environment 100 includes one or more client devices 102 and a back-end computing system 104. One or more client devices 102 and back-end computing system 104 are configured to communicate through network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

For example, network 105 may be the Internet, a private data network, virtual private network using a public network and/or other suitable connection(s) that enables components in computing environment 100 to send and receive information between the components of computing environment 100.

In some embodiments, communication between the elements may be facilitated by one or more application programming interfaces (APIs). APIs of back-end computing system 104 may be proprietary and/or may be examples available to those of ordinary skill in the art such as Amazon® Web Services (AWS) APIs or the like.

In one or more embodiments, client device 102 is operated by a user. Client device 102 may be representative of a mobile device, a tablet, a desktop computer, or any computing system having the capabilities described herein. Users may include, but are not limited to, individuals such as, for example, subscribers, clients, prospective clients, or customers of an entity associated with back-end computing system 104, such as individuals who have obtained, will obtain, or may obtain a product, service, or consultation from an entity associated with back-end computing system 104.

Client device 102 includes at least application 108 and camera 110. Application 108 may be representative of a stand-alone application associated with back-end computing system 104. In some embodiments, application 108 is representative of an accounting software package, such as QuickBooks®, which is commercially available from Intuit, Inc., in Sunnyvale, Calif. In some embodiments, application 108 is representative of a personal financial management application, such as Mint®, which is commercially available from Intuit, Inc., in Sunnyvale, Calif. In some embodiments, application 108 may be representative of a specialized version of a corresponding application, which allows for back-end computing system 104 to monitor a user while interacting with application 108. For example, application 108 may be representative of a specialized version of QuickBooks®, which allows for a user to be monitored while accessing QuickBooks®.

In some embodiments, application 108 is composed of a plurality of dialogues. Each dialog may be representative of a portion of application 108. For example, a first dialog may correspond to a login page for application 108; a second dialog may correspond to a homepage for application 108; a third dialog may correspond to an end-user license agreement page; and the like.

Camera 110 may be configured to capture one or more images or videos while application 108 is in use. In some embodiments, camera 110 will continuously capture one or more images or videos while application 108 is in use. In some embodiments, camera 110 will periodically or intermittently capture one or more images or videos while application 108 is in use. For example, camera 110 may capture an image or video of a user when the user interacts with each dialog of application 108.

Back-end computing system 104 is configured to communicate with one or more of client device 102 and third party servers 106 via network 105. As shown, back-end computing system 104 includes a web client application server 120 and automatic feedback system 122. Automatic feedback system 122 may be comprised of one or more software modules. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather as a result of the instructions.

Automatic feedback system 122 is configured to monitor user interaction with application 108 and automatically generate feedback for application 108 based on the monitored user interaction. In some embodiments, automatic feedback system 122 monitors user interaction with application 108 on a dialog-by-dialog basis. Continuing with the above example, automatic feedback system 122 may monitor user interaction for the first dialog corresponding to the first dialog corresponding to the login page, the second dialog corresponding to the homepage, and the third dialog corresponding the end-user license agreement page. Automatic feedback system 122 may generate a score for the user's experience with each dialog. Based on the individual dialog scores, automatic feedback system 122 may generate a product experience score for application 108. In some embodiments, such product experience score may represent whether the user had a positive experience, a negative experience, or a neutral experience with application 108. Further, by evaluating application 108 on a dialog-by-dialog basis, automatic feedback system 122 can generate individualized product experience scores. In this manner, application 108 may signal to a develop which portions of application 108 may be adjusted to improve user experience.

Client devices 102 and back-end computing system 104 are each depicted as single devices for ease of illustration, but those of ordinary skill in the art will appreciate that client devices 102 or back-end computing system 104 may be embodied in different forms for different implementations. For example, back-end computing system 104 may include a plurality of servers or one or more databases. Alternatively, the operations performed by the back-end computing system may be performed on fewer (e.g., one or two) servers. In some embodiments, a plurality of client devices 102 communicate with back-end computing system 104. A single user may have multiple client devices 102, and/or there may be multiple users each having their own client device(s) 102.

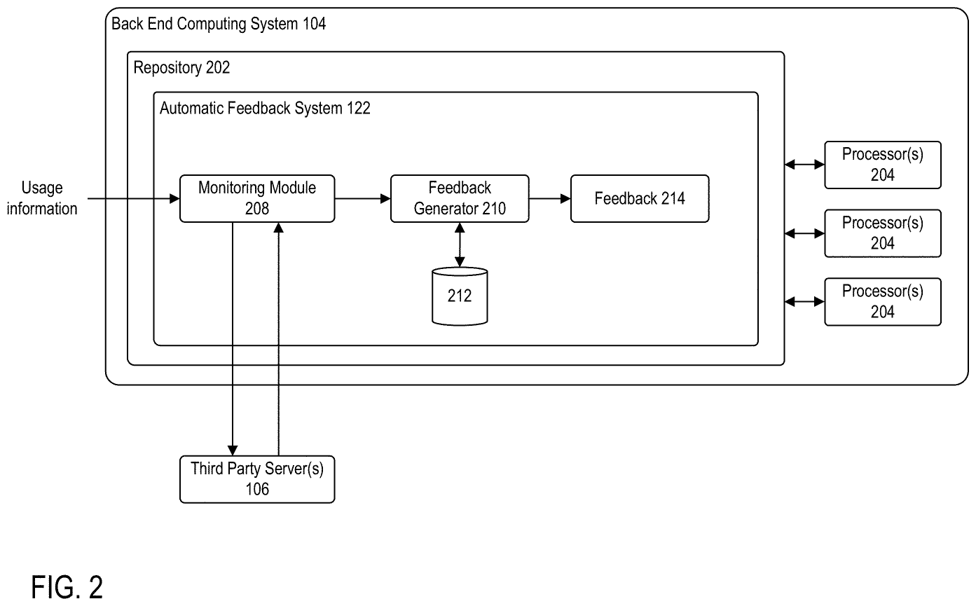

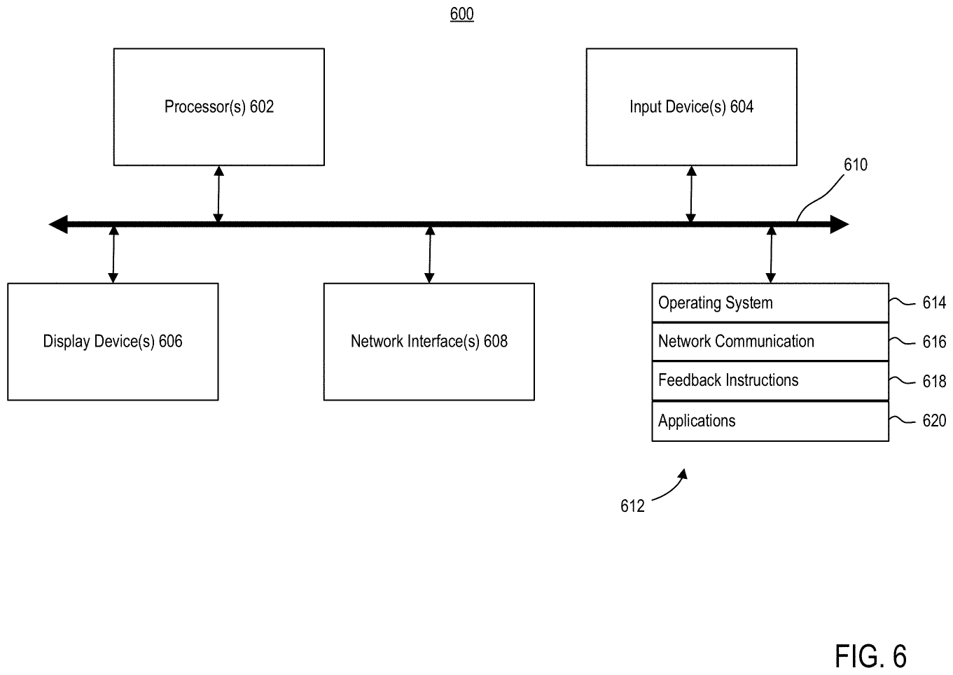

FIG. 2 is a block diagram illustrating back-end computing system 104, according to one or more embodiments disclosed herein. As shown in the illustrated example, back-end computing system 104 includes a repository 202 and one or more computer processors 204. In some embodiments, back-end computing system 104 takes the form of the computing device 600 described in FIG. 6 and the accompanying description below. In one or more embodiments, one or more computer processors 204 take the form of computer processor(s) 602 described in FIG. 6 and the accompanying description below.

Repository 202 is any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes automatic feedback system 122.

Automatic feedback system 122 is configured to automatically generate feedback for an application or portions of an application based on monitored user activity. As shown, automatic feedback system 122 includes monitoring module 208 and feedback generator 210. Each of monitoring module 208 and feedback generator 210 may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather as a result of the instructions.

Monitoring module 208 is be configured to monitor user interaction with application 108. Exemplary user interaction data may include, but is not limited to, one or more of time, emotion, and flow. Time may correspond to the time taken by the user in each dialog. Emotion may correspond to a user's observed emotion while they are within each dialog. Flow may correspond to whether the user executed workflow passed or failed.

In some embodiments, to monitor the time taken in each dialog, monitoring module 208 may determine when the user begins interacting with the dialog. For example, monitoring module 208 may define a start time as the loading and display of the page to the user and an end time as a point just before navigating to another page by any action on the page (e.g., selection of a hyperlink, submission of login credentials, and the like).

In some embodiments, to monitor the user's emotion, monitoring module 208 requests access to a user's camera 110. As those skilled in the art understand, a user can either deny or grant monitoring module 208 access to camera 110. If the user denies monitoring module 208 access to camera 110, monitoring module 208 may monitor only the time and results metrics. If monitoring module 208 is granted access to camera 110, monitoring module 208 may capture image and/or video data of the user while the user is interacting with application 108 or a dialog within application 108. In some embodiments, monitoring module 208 may capture an image of the user as the user passes from one dialog to another. To determine the emotion of the user, monitoring module 208 may provide third party servers 106 with the captured image and/or video data of the user. For example, monitoring module 208 may utilize one or more APIs to provide the image data to Amazon Rekognition hosted by one or more third party servers 106. Amazon Rekognition may generate an output corresponding to the detected emotion and provide that output to monitoring module 208. In some embodiments, the output may be selected from a group that includes the following possible outputs: happy, sad, angry, confused, disgusted, surprised, calm, unknown, and fear.

In some embodiments to monitor the user's workflow, monitoring module 208 may determine whether the user's workflow was successful or unsuccessful (e.g., the user converted or did not convert). For example, consider the situation where a user implements a login workflow. The workflow is deemed successful if the user successfully logs into their account. If a user enters the incorrect email/password combination, the user will be denied access. Such denial of access may be deemed an unsuccessful workflow. In some embodiments, monitoring module 208 may determine whether the user's workflow was abandoned. Continuing with the foregoing example, if the user becomes frustrated or forgets their email/password combination and exits out of application 108, such action may correspond to an abandoned workflow.

In some embodiments, each attempt at the workflow corresponds to a workflow attempt. Monitoring module 208 may monitor user interaction for a given workflow attempt. For example, if a user executes a workflow for a login procedure and enters the wrong password, monitoring module 208 detects the time taken on the dialog for this attempt, the emotion of the user during this attempt, and the result of the workflow (unsuccessful). If the user executes a subsequent workflow for the login procedure and enters the correct password, monitoring module 208 detects the time taken on the dialog for the subsequent attempt, the emotion of the users during the subsequent attempt, and the result of the subsequent workflow (successful). When a user experience score is generated for this dialog, automatic feedback system 122 may consider the user interaction data for each workflow attempt.

Feedback generator 210 is configured to automatically generate feedback for an application or portions of an application based on the monitored user activity. Feedback generator 210 may compare the monitored user activity to baseline data stored in data store 212. Data store 212 may store an xml file that includes baseline data for each dialog of application 108. For example, the xml file may include:

```
<Dialog id=“0” Name=“UpdateDialog” Type=“Mandatory” Weight=“1”
Actual=“0”
Attempts=“0” Calculated=“0”>
<TimeScale id=“1” Actual=“0” Weight=“3” Calculated=“0”>
    <Time Limit=“5” Scale=“10” />
    <Time Limit=“10” Scale=“9” />
    <Time Limit=“15” Scale=“8” />
    <Time Limit=“20” Scale=“7” />
    <Time Limit=“30” Scale=“6” />
    <Time Limit=“40” Scale=“5” />
    <Time Limit=“50” Scale=“4” />
    <Time Limit=“70” Scale=“3” />
    <Time Limit=“90” Scale=“2” />
    <Time Limit=“100” Scale=“1” />
  </TimeScale>
<EmotionScale id=“2” Actual=“0” Weight=“2” Calculated=“0”>
    <Emotion Limit=“1” Scale=“1” />
    <Emotion Limit=“2” Scale=“2” />
    <Emotion Limit=“3” Scale=“3” />
    <Emotion Limit=“4” Scale=“4” />
    <Emotion Limit=“5” Scale=“5” />
    <Emotion Limit=“6” Scale=“6” />
    <Emotion Limit=“7” Scale=“7” />
    <Emotion Limit=“8” Scale=“8” />
    <Emotion Limit=“9” Scale=“9” />
    <Emotion Limit=“10” Scale=“10” />
</EmotionScale>
<FlowScale id=“3” Actual=“0” Weight=“5” Calculated=“0”>
    <Flow Result=“0” Scale=“10” />
    <Flow Result=“1” Scale=“2” />
      <Flow Result=“2” Scale=“4” />
</FlowScale>
```

As shown, the foregoing code represents the baseline values for a first dialog in application 108. The first dialog may have an ID number, a name, a type, and a weight. The ID number may be set by a developer and uniquely represents the dialog. The name may correspond to the name of the dialog. In this example, the name corresponds to “UpdateDialog.” The type corresponds to whether the dialogue is mandatory or optional. The weight may correspond to the overall importance of the dialog within application 108. In this example, the weight may be “1.” In some embodiments, the first dialog may further include a count of attempts. The “actual” attribute corresponds to the exact value picked by matching with the baseline values given under the time/emotion/flow nodes. For example, if the take taken at the upload dialogue is seven seconds, “actual” will be 9 (e.g., based on the baseline scale value). The “calculated” corresponds to the actual multiplied by the weight specified at the time scale. Here, the weight equals 3; thus, the calculated is 27.

As shown, the first dialog code further includes baseline data for a time flow metric. The time flow metric may be based on the monitored time taken on a dialog. The time flow metric may include a weight associated therewith. The weight may indicate the importance of the time flow metric to the overall score of the first dialog. The time flow metric may define ranges of time and scores they correspond thereto. For example, if it takes the user five seconds or less the navigate through the first dialog, the time flow metric score may be “10.” Similarly, if it takes the user 35 seconds to navigate through the first dialog, the time flow metric score may be “5.”

The first dialog code may further include baseline data for the emotion metric. The emotion metric may include a weight associated therewith. The weight may indicate the importance of the emotion metric to the overall score of the first dialog. The emotion metric may include scores for each possible emotion output generated by third party servers 106. For example, angry (1), disgusted (2), sad (3), fear (4), confused (5), neutral (6), calm (7), satisfied (8), happy (9), surprised (10). Accordingly, based on the output from third party servers 106, feedback generator 210 may compare the output to the baseline data for the emotion metric to obtain the appropriate value.

The first dialog code may further include baseline data for the flow scale or result metric. The flow scale metric may include a weight associated therewith. The weight may indicate the importance of the flow scale metric to the overall score of the first dialog. The flow scale metric may include one or more values: a flow result of 0 may correspond to the user having successfully navigated the dialog; a flow result of 1 may correspond to the user unsuccessfully navigating the dialog; and a flow result of 2 may correspond to the user cancelling the dialog.

Based on the comparison to the baseline values, feedback generator 210 may generate raw feedback values for each of the time flow metric, the emotion metric, and the flow scale metric for a given dialog i. Feedback generator 210 may utilize these values to compute a weighted average value (Dᵢ) of the user experience based on the monitored user activity. Mathematically, this may be represented as:

$${D}_{i} = \frac{( {T}_{i} * {WT}_{i} ) + ( {E}_{i} * {WE}_{i} ) + ( {F}_{i} * {WF}_{i} )}{{WT}_{i} + {WE}_{i} + {WF}_{i}}$$

where Tᵢ represents the time taken at dialog i, WTᵢ represents the weight assigned to the timing factor Tᵢ, Eᵢ represents the user's emotion at dialog i, WEᵢ represents the weight assigned to emotion factor Eᵢ, Fᵢ represents the flow result at dialog i, and WFᵢ represents the weight assigned to the dialog flow factor Fᵢ.

As provided above, in some embodiments, it may take the user multiple attempts to successfully navigate a dialog. In such embodiments, automatic feedback system 122 monitors the user for each dialog attempt and averages these values to generate the weighted average value. For example, assume for dialog i, the time flow metric taken for the first attempt is T1 and the time taken for the second attempt is T2. Feedback generator 210 may take the average of these values, i.e.,

$$\frac{T 1 + T 2}{2} = {T}_{avg} ,$$

and use that value for comparison against the baseline values. Continuing with the foregoing example, if T1=5 seconds and T2=35 seconds, then T_{avg}=20 seconds and the corresponding time flow metric value will be 7.

Feedback generator 210 may generate a weighted average for each dialog Dᵢ, where i∈[0,N]. To generate an overall user experiences core, feedback generator 210 generates the weighted average values across all dialogs. For example:

$$Overall Product Rating = {\sum }_{1}^{N} \frac{{D}_{i} * {W}_{i}}{{W}_{i}}$$

where Wᵢ represents the weight assigned to the dialog.

Using the overall product rating and the individual weighted averages for each dialog, feedback generator 210 generates feedback 214. For example, feedback generator 210 may utilize the generated outputs to automatically fill out and submit a feedback form for application 108.

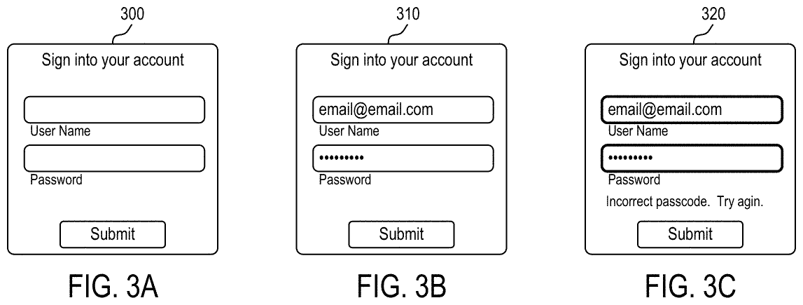

FIGS. 3A-3C illustrate an exemplary dialogue of application 108 at various stages of a workflow, according to example embodiments. The workflow illustrated across FIGS. 3A-3C corresponds to workflow for a login dialog. At stage 300, a user may be initially presented with the login dialog. As shown, the login dialog asks the user to sign into its account with a username and password. A user can successfully navigate the workflow by providing the correct credentials to the login dialog. When the user is initially presented with the login dialog, monitoring module 208 may begin a counter to determine how long it takes the user to navigate the workflow. In some embodiments, monitoring module 208 may also access camera 110 of client device 102 to capture an image of the user.

At stage 310, the user has entered its username and password. The user may submit the username and password for authentication. If the username and password combination is incorrect, the user will be presented with an error message as shown at stage 320. In some embodiments, when the error message is presented, monitoring module 208 may stop the timer. In some embodiments, when the error message is presented, monitoring module 208 may reset the timer to capture time for the next attempt. In some embodiments, monitoring module 208 may also capture an image of the user interacting with the login dialog. Based on the error message, monitoring module 208 may determine that the workflow was unsuccessful. As such, monitoring module 208 has gathered time data, image data, and flow data for a first attempt at a workflow with the login dialog.

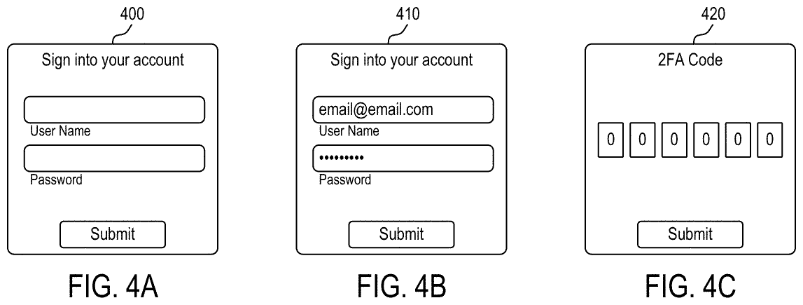

FIGS. 4A-4C illustrate an exemplary dialogue of application 108 at various stages of a workflow, according to example embodiments. The workflow illustrated across FIGS. 4A-4C corresponds to second attempt at the workflow with the login dialog illustrated in FIGS. 3A-3C. At stage 400, the user may be initially presented with the login dialog. As shown, the login dialog asks the user to sign into their account with its username and password. A user can successfully navigate the workflow by providing the correct credentials to the login dialog. When the user is initially presented with the login dialog, monitoring module 208 may begin a counter to determine how long it takes the user to navigate the workflow. In some embodiments, monitoring module 208 may also access camera 110 of client device 102 to capture an image of the user.

At stage 410, the user has entered his/her username and password. The user may submit the username and password for authentication. If the username and password combination is correct, the user will be presented with a further prompt to enter their two-factor authentication (2FA) code, as shown at stage 420. If the user successfully enters their 2FA code, the user will have successfully navigated the workflow. However, if the user enters the incorrect 2FA code, the user unsuccessfully navigated the workflow. In either embodiment, following submission of the 2FA code, monitoring module 208 may stop the timer. In some embodiments, monitoring module 208 may also capture an image of the user interacting with the login dialog. As such, monitoring module 208 has gathered time data, image data, and flow data for the second attempt at a workflow with the login dialog.

Using the date from the first attempt and the second attempt, automatic feedback system 122 may generate a weighted average for the login dialog.

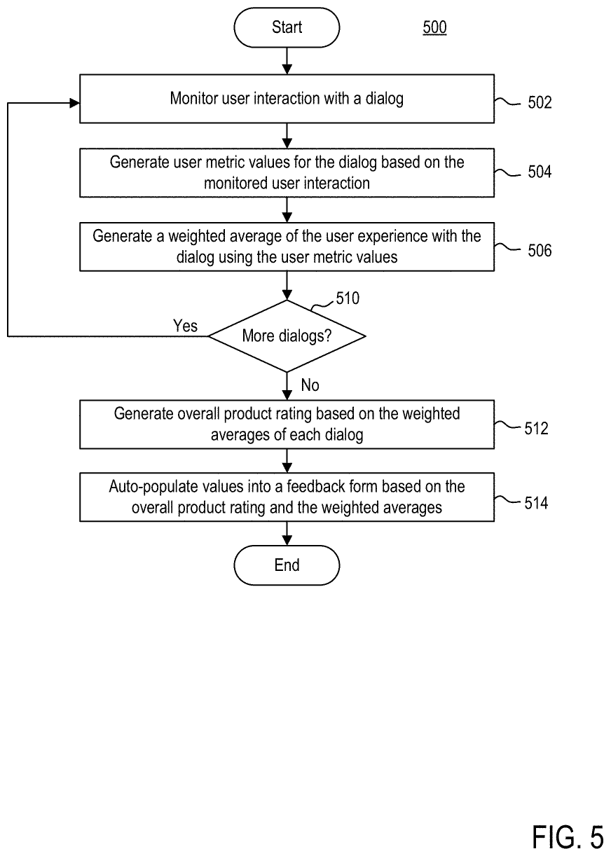

FIG. 5 is a flow diagram illustrating a method 500 of automatically generating user feedback for an application, according to example embodiments. Method 500 may begin at step 502.

At step 502, back-end computing system monitors user interaction with a dialog. Monitoring user interaction with the dialog may include monitoring module 208 capturing one or more of a time data, emotion data, and a flow data while the user is executing a workflow. The time data may correspond to the time taken by the user in each dialog. The emotion data may correspond to a user's observed emotion while they are within each dialog. The flow data may correspond to whether the user executed workflow was successful or unsuccessful.

In some embodiments, monitoring module 208 is configured to access emotion data. For example, monitoring module 208 may be granted access to camera 110 by the user. In such embodiments, monitoring module 208 may capture an image or a video of the user, while the user is interacting with the dialog. Monitoring module 208 may leverage functionality of one or more third party servers 106 (e.g., Amazon Rekognition) to receive emotion data corresponding to the captured image data.

At step 504, back-end computing system 104 generates user metric values for the dialog based on the monitored user interaction data. To generate the user metric values, feedback generator 210 compares the monitored user activity to baseline data stored in data store 212. Data store 212 may store an xml file that includes baseline data for each dialog of application 108. By comparing the raw, user metric values captured by monitoring module 208, feedback generator 210 can normalize or standardize the values for downstream generation of a weighted average representing the user's experience with the dialog. For example, based on the time data, feedback generator 210 can generate the time flow metric. In another example, based on the flow data, feedback generator 210 can generate the flow scale metric.

At step 506, back-end computing system 104 generates a weighted average of the user experience with the dialog using the user metric values. Feedback generator 210 uses the user metric values to compute a weighted average value (Dᵢ) of the user experience based on the monitored user activity. Mathematically, this may be represented as:

$${D}_{i} = \frac{( {T}_{i} * {WT}_{i} ) + ( {E}_{i} * {WE}_{i} ) + ( {F}_{i} * {WF}_{i} )}{{WT}_{i} + {WE}_{i} + {WF}_{i}}$$

where Tᵢ represents the time scale metric at dialog i (e.g., the time taken at dialog i), WTᵢ represents the weight assigned to the timing factor Tᵢ, Eᵢ represents the user's emotion at dialog i, WEᵢ represents the weight assigned to emotion factor Eᵢ, Fᵢ represents the flow scale metric at dialog i, and WFᵢ represents the weight assigned to the dialog flow factor Fᵢ.

In some embodiments, it may take the user multiple attempts to successfully navigate a dialog. In such embodiments, automatic feedback system 122 monitors the user for each dialog attempt and averages these values to generate the weighted average value.

At step 510, back-end computing system 104 determines whether there are any more dialogs for analysis. If, at step 510, automatic feedback system 122 determines there are additional dialogs for analysis, then method 500 reverts back to step 502 for monitoring and analysis of a subsequent dialog. If, however, at step 510, automatic feedback system 122 determines that there are not any additional dialogs, method 500 may proceed to step 512.

At step 512, back-end computing system 104 generates an overall product experience score based on the weighted averages of each dialog. To generate an overall user experience score, feedback generator 210 accesses data store 212 to obtain the weights for each individual dialog. Using the weights, feedback generator 210 generates the weighted average values across all dialogs. For example:

$$Overall Product Rating = {\sum }_{1}^{N} \frac{{D}_{i} * {W}_{i}}{{W}_{i}}$$

where Wᵢ represents the weight assigned to the dialog, which determines the importance of the dialog to the overall application workflow.

In some embodiments, method 500 includes step 514 where back-end computing system 104 auto-populates values into a feedback form based on the overall product rating and weighted average. For example, based on the overall product experience score, feedback generator 210 may determine a user's overall experience with the application. Similarly, using each individual weighted average, feedback generator 210 may auto-populate feedback related to specific portions of the application.

FIG. 6 shows an example computing device according to an embodiment of the present disclosure. For example, computing device 600 may function as back-end computing system 104. The computing device 600 may include a service that provides automatic feedback generation functionality as described above or a portion or combination thereof in some embodiments. The computing device 600 may be implemented on any electronic device that runs software applications derived from compiled instructions, including without limitation personal computers, servers, smart phones, media players, electronic tablets, game consoles, email devices, etc. In some implementations, the computing device 600 may include one or more processors 602, one or more input devices 604, one or more display devices 606, one or more network interfaces 608, and one or more computer-readable mediums 612. Each of these components may be coupled by bus 610, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, camera, and touch-sensitive pad or display. Bus 610 may be any known internal or external bus technology, including but not limited to ISA, EISA, PCI, PCI Express, USB, Serial ATA or FireWire. Computer-readable medium 612 may be any non-transitory medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 612 may include various instructions for implementing an operating system 614 (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 612; controlling peripheral devices (e.g., disk drives, printers, etc.) which can be controlled directly or through an I/O controller; and managing traffic on bus 610. Network communications instructions 616 may establish and maintain network connections (e.g., software for implementing communication protocols, such as TCP/IP, HTTP, Ethernet, telephony, etc.).

Automated feedback instructions 618 may include instructions that enable computing device 600 to function as an automatic feedback system as described herein. Application(s) 620 may be an application that uses or implements the processes described herein and/or other processes. The processes may also be implemented in operating system 614. For example, application 620 and/or operating system 614 may execute one or more operations to monitor user interaction with an application and automatically generate user feedback based on the monitored user interaction.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

It is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

Finally, embodiments disclosed herein are provided in the attached Appendix. It should be appreciated, however, that the examples set forth in the Appendix are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

What is claimed is:

1. A method performed by a computing system comprising:
monitoring interaction of a user with a dialog in an application executing on a user device associated with the user, the user executing a workflow associated with the dialog;
determining a time the user spent executing the workflow associated with the dialog based on the monitoring;
determining whether the user successfully executed the workflow based on the monitoring;
generating a time flow metric for the dialog based on the time the user spent interacting with the dialog;
generating a flow scale metric based on whether the user successfully executed the workflow; and
automatically generating a user experience rating for the dialog based on the time flow metric and the flow scale metric, wherein the user experience rating is a weighted representation of the time flow metric and the flow scale metric.

2. The method of claim 1, further comprising:
generating an overall user experience rating for the application based on the weighted representation of the user experience rating with the dialog and a second weighted representation of a second user experience rating with a second dialog.

3. The method of claim 2, further comprising:
auto-populating a plurality of fields in a user feedback form based on the overall user experience rating, the user experience rating, and the second user experience rating.

4. The method of claim 1, further comprising:
monitoring second user interaction with the dialog in the application, wherein the user is re-executing the workflow with the dialog;
determining a second time the user spent re-executing the workflow associated with the dialog based on the monitoring;
determining whether the user successfully re-executed the workflow based on the monitoring;
generating an average time the user spent executing the workflow based on the time and the second time;
generating an average success of the user executing the workflow based on the monitoring;
generating an average time flow metric for the dialog based on the average time;
generating an average flow scale metric based on the average success; and
automatically generating a second user experience rating for the dialog based on the average time and the average success.

5. The method of claim 1, further comprising:
determining emotion data based on the monitoring.

6. The method of claim 5, wherein determining the emotion data comprises:
accessing a camera associated with the user device;
capturing image data of the user while the user is interacting with the dialog; and
deriving the emotion data from the captured image data.

7. The method of claim 6, wherein deriving the emotion data from the capture image data comprises:
accessing an application programming interface of a third party server to generate the emotion data based on the captured image data.

8. The method of claim 7, further comprising:
generating an emotion metric for the dialog by comparing the emotion data to a first dialog code comprising baseline data for a plurality of emotions.

9. The method of claim 1, wherein generating the time flow metric for the dialog based on the time the user spent interacting with the dialog comprises:
comparing the time to a first dialog code mapping time flow results to corresponding time flow metrics to generate the time flow metric.

10. The method of claim 1, wherein generating the user experience rating with the dialog comprises:
determining a first weight associated with the time flow metric, the first weight corresponding to an importance of the time flow metric to the dialog; and
determining a second weight associated with the flow scale metric, the flow scale metric corresponding to an importance of the flow scale metric to the dialog.

11. A non-transitory computer readable medium comprising one or more sequences of instructions, which, when executed by a processor, causes a computing system to perform operations comprising:
monitoring interaction of a user with a dialog in an application executing on a user device associated with the user, the user executing a workflow associated with the dialog;
determining a time the user spent executing the workflow associated with the dialog based on the monitoring;
determining whether the user successfully executed the workflow based on the monitoring;
generating a time flow metric for the dialog based on the time the user spent interacting with the dialog;
generating a flow scale metric based on whether the user successfully executed the workflow; and
automatically generating a user experience rating for the dialog based on the time flow metric and the flow scale metric, wherein the user experience rating is a weighted representation of the time flow metric and the flow scale metric.

12. The non-transitory computer readable medium of claim 11, further comprising:
generating an overall user experience rating for the application based on the weighted representation of the user experience rating and a second weighted representation of a second user experience rating with a second dialog.

13. The non-transitory computer readable medium of claim 12, further comprising:
auto-populating a plurality of fields in a user feedback form based on the overall user experience rating, the user experience rating, and the second user experience rating.

14. The non-transitory computer readable medium of claim 11, further comprising:
monitoring second user interaction with the dialog in the application, wherein the user is re-executing the workflow with the dialog;
determining a second time the user spent re-executing the workflow associated with the dialog based on the monitoring;
determining whether the user successfully re-executed the workflow based on the monitoring;
generating an average time the user spent executing the workflow based on the time and the second time;
generating an average success of the user executing the workflow based on the monitoring;
generating an average time flow metric for the dialog based on the average time; generating an average flow scale metric based on the average success; and
automatically generating a second user experience rating for the dialog based on the average time and the average success.

15. The non-transitory computer readable medium of claim 11, further comprising:
determining emotion data based on the monitoring.

16. The non-transitory computer readable medium of claim 15, wherein determining the emotion data comprises:
accessing a camera associated with the user device;
capturing image data of the user while the user is interacting with the dialog; and
deriving the emotion data from the captured image data.

17. The non-transitory computer readable medium of claim 16, wherein deriving the emotion data from the capture image data comprises:
accessing an application programming interface of a third party server to generate the emotion data based on the captured image data.

18. The non-transitory computer readable medium of claim 17, further comprising:
generating an emotion metric for the dialog by comparing the emotion data to a first dialog code comprising baseline data for a plurality of emotions.

19. The non-transitory computer readable medium of claim 11, wherein generating the time flow metric for the dialog based on the time the user spent interacting with the dialog comprises:
comparing the time to a first dialog code mapping time flow results to corresponding time metric metrics to generate the time flow metric.

20. The non-transitory computer readable medium of claim 11, wherein generating the user experience rating with the dialog comprises:
determining a first weight associated with the time flow metric, the first weight corresponding to an importance of the time flow metric to the dialog; and
determining a second weight associated with the flow scale metric, the flow scale metric corresponding to an importance of the flow scale metric to the dialog.
